(19) United States
(12) Patent Application Publication
(10) Pub. No.: US 2026/0328570 A1
(43) Pub. Date: Oct. 22, 2026

(54) NAVIGATION METHOD AND DEVICE FOR A VEHICLE, AND ASSOCIATED SYSTEM, VEHICLE, COMPUTER PROGRAM AND STORAGE MEDIUM

(71) Applicant: SAFRAN ELECTRONICS & DEFENSE, Paris (FR)

(72) Inventors: Raphaël JARRAUD, Moissy-Cramayel (FR); Clément GROSHENS, Moissy-Cramayel (FR); Philippe ELIE

(73) Assignee: SAFRAN ELECTRONICS & DEFENSE, Paris (FR)

(21) Appl. No.: 19/110,558

(22) PCT Filed: Sep. 12, 2023
(86) PCT No.: PCT/FR2023/051388

§ 371 Date: Mar. 11, 2025

(30) Foreign Application Priority Data
Sep. 13, 2022 (FR) 2209165

(51) Int. Cl. G01C 21/16; G01C 21/00; G01S 19/47

(52) U.S. Cl. CPC G01C 21/1656; G01C 21/005; G01S 19/47

(57) ABSTRACT

A navigation method and device, where the method includes the steps of: determining, by a first navigation module, first navigation data of the vehicle based on data from an inertial measurement unit and from a satellite positioning module; and determining, by a second navigation module, second navigation data of the vehicle based on: data from the inertial measurement unit, and from images captured by the vehicle; and moreover based on data from the satellite positioning module and/or from an altimeter.

### TECHNICAL FIELD

This invention relates to the fields of navigation and positioning. More specifically, this invention relates to a navigation method and device for a vehicle, and associated system, vehicle, computer program and information medium. This invention has a particularly advantageous, though in no way limiting, application for the implementation of aircraft navigation systems.

### PRIOR ART

Today, in the prior art, different navigation systems for vehicles exist. In particular, it is known to use, on board a vehicle, an inertial system as a navigation system. More generally, “inertial navigation” will hereinafter refer to a navigation solution exploiting data from an inertial measurement unit (i.e. specific force and angular velocity). The exploitation of inertial data to implement a navigation solution does however presuppose the well-known problem of drift over time of the inertial navigation. Specifically, small measurement errors on the specific force and on the angular velocity are integrated over time by the inertial navigation and thus lead to increasingly large errors in velocity and position.

To limit the drift of an inertial navigation, one approach of the prior art consists in combining inertial data with data from a satellite positioning module, such as a GPS (Global Positioning System) module. In general, a navigation solution combining data from several sensors is described as a “hybrid navigation” solution. Existing inertia-GPS hybrid navigation solutions do however have the following drawback: a GPS module can be easily scrambled and thus encounter a loss of availability.

Finally, inertia-GPS hybrid navigation solutions do not allow to reliably and accurately locate a vehicle while guaranteeing a high level of integrity. Integrity is defined as the ability to supply, in addition to an estimated quantity (e.g. the position, velocity, or heading of a vehicle), a radius of protection associated with this quantity, i.e. an upper bound on the estimation error with a definite probability, in particular very close to 1.

The use of computer vision techniques may also be envisioned to offset the drift of an inertial navigation based on images captured by a vehicle. However, existing computer vision devices—both cameras and image processing algorithms-have a low level of maturity such that the reliability of these devices is low. In particular, such devices have a high integrity risk per hour. The integrity risk per hour for a navigation system is defined as the risk per hour of obtaining an erroneous item of information, i.e. an estimated quantity, the error on which is greater than the radius of protection. In this sense, making use of a computer vision device to implement a navigation solution does not allow to achieve an adequate integrity level for critical applications, such as aerospace.

There is consequently a need for a navigation solution allowing to improve the level of integrity and availability of existing navigation systems.

### SUMMARY OF THE INVENTION

This invention has the aim of remedying all or part of the drawbacks of the prior art, particularly those set out previously.

For this purpose, according to an aspect of the invention, provision is made for a navigation method for a vehicle, said method comprising steps of:
determining, by a first navigation module, first navigation data of said vehicle based on data from an inertial measurement unit and from a satellite positioning module; and determining, by a second navigation module, second navigation data of said vehicle based on: data from the inertial measurement unit and from images captured by said vehicle; and moreover based on data from said satellite positioning module and/or from an altimeter.

The term “navigation data” here refers to: data relating to the position, and/or the displacement of the vehicle—such as geographical coordinates (e.g. latitude, longitude, altitude), a velocity, a heading etc.; and/or radii of protection associated with position/displacement data. In the context of the invention, a “position” may refer to an absolute position defined with respect to the terrestrial frame of reference, or a relative position defined with respect to a reference position.

In the context of the invention, the term “inertial measurement unit” refers to a measuring device providing, for a plurality of measuring times, data relative to the specific force (i.e. the sum of the external forces other than gravitational forces, divided by the mass) and the angular velocity of the vehicle. Furthermore, the term “inertial system” hereinafter refers to a navigation device integrating over time the specific force and angular velocity data produced by an inertial measurement unit and allowing to determine navigation data of the vehicle.

The proposed method allows to accurately determine the navigation data of a vehicle (e.g. the position and displacement data of the vehicle as well as the associated radii of protection) while guaranteeing a high level of integrity and availability of the navigation system.

According to an embodiment, the step of determining of navigation data by the first navigation module and the step of determining of navigation data by the second navigation module are done concomitantly (i.e. in parallel, or simultaneously). Thus, the parallel use of two separate navigation modules (i.e. said first and second navigation modules) can improve the resilience of the navigation system of the vehicle with respect to malfunctions of the sensors used for navigation (e.g. satellite positioning module, image capture device), such as a malfunction of the satellite positioning module, a malfunction of the image capture device, or an unavailability of another sensor etc.

Furthermore, the use of a satellite positioning module and images allows to offset the inertial navigation drift and thus to accurately determine the navigation data of the vehicle.

By comparison with existing navigation solutions, the navigation solution for which provision is made, by exploiting a plurality of navigation modules, allows to improve the level of integrity and availability of the vehicle navigation system while accurately determining the navigation data of the vehicle.

More accurately, the proposed navigation solution has: a higher level of availability than existing inertia-GPS hybrid navigation systems; and a higher level of integrity than existing inertia-vision hybrid navigation systems.

According to an embodiment, the proposed method comprises steps of:
if said satellite positioning module is operational, providing said first navigation data to a guiding module of said vehicle; and
otherwise, providing said second navigation data to said guiding module of said vehicle.

This embodiment allows to accurately guide a vehicle. Note that this embodiment benefits from the technical advantages of the navigation solution for which provision is made. Specifically, an accurate guiding of the vehicle is enabled since the navigation data are determined with accuracy.

As mentioned previously, the proposed solution exploits images for navigation to offset the inertial navigation drift. According to this embodiment, the use of the navigation data determined based on images by the second navigation module for the guiding of the vehicle is conditional on the unavailability of the satellite positioning module (e.g. module malfunctioning or unusable). Thus, this embodiment allows to significantly relax the restrictions on reliability (i.e. integrity risk per hour) of the image capture device and the associated image processing algorithms. Thus, the proposed navigation solution allows to accurately determine the navigation data of a vehicle while guaranteeing a high level of integrity, even for an associated image capture device and image processing algorithms with low maturity.

Specifically, the second navigation module exploits, according to this embodiment, data from a satellite positioning module or from the altimeter in addition to the captured images. This allows to offset, with better accuracy, the inertial navigation drift of the second navigation module when the satellite positioning module or the altimeter are usable. Thus, this embodiment allows to keep an accurate localization chain by exploiting the different sensors when they are available.

For example, supposing that during a first period, the second navigation module uses the data from the satellite positioning module to offset the inertial navigation drift. Then, during a second later period, the satellite positioning module is no longer available. Then, even though the satellite positioning module is no longer available, the second navigation module benefits during the second period from the recalibration of the inertial navigation during the first period.

The same goes for the first navigation module which exploits the data from the satellite positioning module when the latter is available. Thus, the first and second navigation modules use, according to this embodiment, the data from the satellite positioning module (only) when the latter is operational.

According to an embodiment, the first and second navigation modules respectively comprise an inertial system and a Kalman filter to determine said first and second navigation data. More specifically, the first navigation module comprises a first inertial system and a first Kalman filter for determining said first navigation data; and the second navigation module comprises a second inertial system and a second Kalman filter for determining said second navigation data.

This embodiment allows to exploit the data from independent sensors and of different types to determine the navigation data of the vehicle effectively, particularly in terms of accuracy of the navigation data obtained and hardware and software resources required (e.g. processing resources, memory resources, etc.).

More precisely, this embodiment allows to implement a fusion of multi-sensor data to determine navigation data of the vehicle. The use of an inertial system allows to determine navigation data based on the inertial data; and the use of a Kalman filter allows to correct these navigation data based on data from the other sensors (i.e. recalibration of the inertial navigation to palliate the drift). Thus, the combination of an inertial system and a Kalman filter allows to implement a fusion of multi-sensor data to accurately determine the navigation data of the vehicle based on independent sensors and sensors of different types.

According to an embodiment, the proposed method comprises steps of:
detecting at least one terrestrial reference point in said captured images;
determining an observed relative position of said at least one detected terrestrial reference point with respect to said vehicle based on said captured images;
determining an estimated relative position of said at least one detected terrestrial reference point with respect to said vehicle based on a position of said vehicle determined by the second navigation module and on a known position of said at least one terrestrial reference point; and
determining said second navigation data based on the difference between the observed and estimated relative positions of said at least one terrestrial reference point with respect to said vehicle.

In the context of the invention, a “terrestrial reference point” is a terrestrial point, the position of which (e.g. the geographical coordinates) is known. Hereinafter, a terrestrial reference point is also referred to by the term “landmark”.

This embodiment allows to palliate the drift of the inertial navigation of the second navigation module based on images captured by the vehicle.

It should also be mentioned that, in the scope of the invention, other embodiments could be envisioned in which navigation data are determined based on images captured, for example, using visual odometry techniques, cartographic recalibration techniques, automatic learning algorithms, etc.

According to an embodiment, said step of detecting at least one terrestrial reference point in the captured images comprises steps of:
selecting a portion of at least one captured image, the coordinates of said portion being determined based on a known position of said at least one terrestrial reference point, on a position of said vehicle determined by the second navigation module and on an item of information relating to the accuracy of said determined position of said vehicle provided by the second navigation module; and
detecting said at least one terrestrial reference point in said portion of said at least one captured image.

This embodiment is advantageous in that it allows to use only an image portion (i.e. a region of interest) to detect a terrestrial reference point and thus restrict the image portion to be processed. More generally, this embodiment allows to reduce the hardware and software resources (e.g. processing resources, memory resources, etc.) required for the detection of a terrestrial reference point in captured images and therefore the determination of navigation data based on captured images.

According to another aspect of the invention, provision is made for a navigation device for a vehicle comprising:
a first navigation module configured to determine first navigation data of said vehicle based on data from an inertial measurement unit and from a satellite positioning module; and
a second navigation module configured to determine second navigation data of said vehicle based on data from the inertial measurement unit and from images captured by said vehicle; and moreover based on data from said satellite positioning module and/or from an altimeter.

The navigation proposed device has the advantages described above in relation with the proposed navigation method. According to an embodiment, the navigation device implements all or part of the steps of the proposed navigation method.

According to an embodiment, the proposed device comprises a control module configured to:
if said satellite positioning module is operational, provide said first navigation data to a guiding module of said vehicle; and
otherwise, provide said second navigation data to said guiding module of said vehicle

According to an aspect of the invention, provision is made for a navigation system for a vehicle comprising: a navigation device in accordance with the invention; an inertial measurement unit; a satellite positioning module; and an image capture device.

The navigation system has the advantages described above in relation to the proposed navigation method. According to an embodiment, the navigation system implements all or part of the steps of the proposed navigation method.

According to an embodiment, the navigation system comprises a computer vision device configured to determine at least one position of the vehicle based on the images captured by said image capture device.

According to an embodiment, the navigation system comprises a guiding module configured to guide said vehicle based on navigation data determined by said navigation device in accordance with the invention.

According to an aspect of the invention, provision is made for a vehicle comprising a navigation system in accordance with the invention.

According to an aspect of the invention, provision is made for a computer program comprising instructions for implementing the steps of a method in accordance with the invention, when the computer program is executed by at least one processor or a computer.

The computer program can be formed of one or more sub-parts stored in one and the same memory or in separate memories. The program can use any programming language, and be in the form of source code, object code, or intermediate code between source code and object code, such as in a partially compiled form, or in any other desirable form.

According to an aspect of the invention, provision is made for an information medium readable by a computer comprising a computer program in accordance with the invention.

The information medium can be any entity or device capable of storing the program. For example, the medium may include a storage means, such as a non-volatile memory or ROM, for example a CD-ROM or a microelectronic circuit ROM, or else a magnetic recording means, for example a diskette or a hard disk.

Moreover, the storage medium can be a transmissible medium such as an electrical or optical signal, which can be conveyed via an electrical or optical cable, by radio or by a telecommunication network or by a computer network or by other means. The program according to the invention can in particular be downloaded over a computer network. Alternatively, the information medium can be an integrated circuit into which the program is incorporated, the circuit being suitable for executing or for being used in the execution of the method in question.

### BRIEF DESCRIPTION OF THE DRAWINGS

Other features and advantages of this invention will become apparent from the description provided hereinafter of embodiments of the invention. These embodiments are given by way of illustrative example and are devoid of any limitation. The description provided hereinafter is illustrated by the attached drawings:

FIG. 1 schematically represents an example of software and hardware architecture of a navigation system according to an embodiment of the invention;

FIGS. 2A and 2B represent, schematically and in the form of a flow chart, steps of a navigation method according to an embodiment of the invention; and

FIG. 3 schematically represents an example of software and hardware architecture of a navigation system according to an embodiment of the invention.

### DESCRIPTION OF THE EMBODIMENTS

This invention relates to a navigation method and device for a vehicle, along with associated system, vehicle, computer program and storage medium.

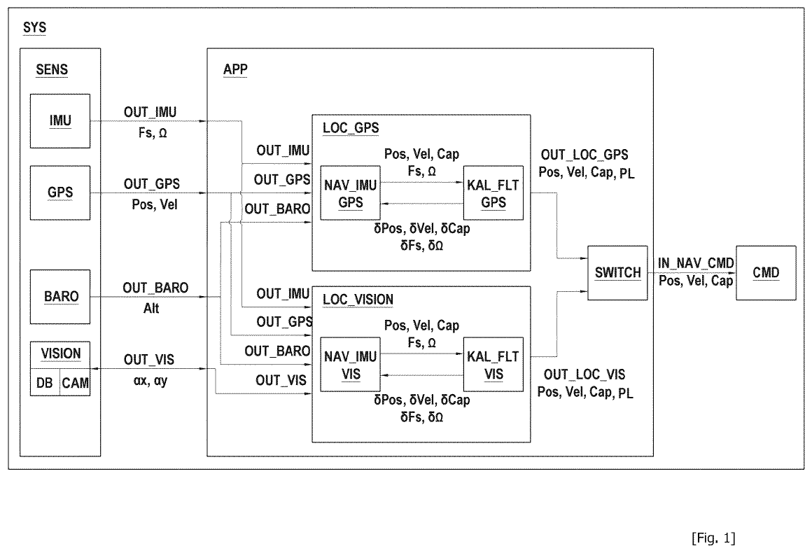

FIG. 1 schematically represents an example of a software and hardware architecture of a navigation system according to an embodiment of the invention.

As illustrated by FIG. 1, according to an embodiment, the navigation system SYS proposed for a vehicle comprises at least one of the following elements: a set of sensors SENS; a navigation device APP; and a guiding module CMD.

The navigation device APP is configured to determine, based on the data from the set of sensors SENS, navigation data IN_NAV_CMD of the vehicle.

The guiding module CMD is configured to guide the vehicle based on the navigation data IN_NAV_CMD provided by the device APP.

According to an embodiment, the system SYS is embedded in a vehicle, for example in a terrestrial vehicle: car, truck, train etc., or in a marine vehicle: boat, frigate, or else in an aerial vehicle: an aircraft, a helicopter, an airplane, a drone, etc. In particular, the system SYS is in a variant embodiment on board an ax.

In the context of the invention, the term “navigation data of a vehicle” refers to data relating to the position, and/or to the displacement of the vehicle and comprise, for example, geographical coordinates (e.g. latitude, longitude, altitude), a velocity, or a heading. The navigation data can be defined absolutely with respect to the terrestrial frame of reference, or relatively with respect to a reference position (e.g. a runway). By way of example, a relative position of the vehicle at a given time determined by the navigation device APP may comprise one or more coordinates of the following set: an azimuth, a vertical distance, a longitudinal distance, and a lateral distance defined with respect to a reference position.

As illustrated by FIG. 1, according to an embodiment, the set of sensors SENS comprises at least one of the following sensors: at least one inertial measurement unit IMU; at least one satellite positioning module GPS; at least one altimeter BARO; a sensor VISION (hereinafter referred to as a computer vision device or sensor); at least one odometer; a Pitot probe; and a magnetometer.

The inertial measurement unit IMU provides data OUT_IMU, also known as inertial data. According to an embodiment, the inertial data OUT_IMU comprise, for a plurality of measurement times, data relating to the specific force Fs (i.e. the sum of the external forces, other than gravitational forces, divided by the mass) and the angular velocity Q of the vehicle. Typically, the inertial measurement unit IMU comprises: three gyroscopes measuring the three components of the angular velocity Q (velocities of variation of the roll, pitch and yaw); and three accelerometers measuring the three components of the specific force Fs.

The satellite positioning module GPS provides navigation data OUT_GPS.

According to an embodiment, the navigation data OUT_GPS comprise, for a plurality of measurement times, a position Pos and a velocity Vel of the vehicle. Typically, the satellite positioning module GPS provides an absolute position Pos with respect to the terrestrial frame of reference comprising one or more coordinates of the following set: the latitude, the longitude; and the altitude. According to an embodiment, the satellite positioning module is compliant with the Global Positioning System, more commonly referred to by the acronym GPS. However, within the scope of the invention, other embodiments could also be envisioned in which all types of GNSS (Global Navigation Satellite System) modules would be used, such as Galileo, Glonass modules etc.

The altimeter BARO provides as output so-called altimetric data OUT_BARO.

The altimeter BARO is, according to an embodiment, a barometric altimeter. In particular, the altimetric data OUT_BARO are, for a plurality of measurement times, representative of the altitude Alt of the vehicle or of variations in altitude of said vehicle.

The computer vision sensor VISION (also referred to as “computer vision device”) provides as output data OUT_VIS. According to an embodiment, the sensor VISION comprises or is configured to communicate with: a recording medium DB; and an image capture device CAM. The recording medium DB, for example a database, comprises the positions (i.e. geographical coordinates) of a plurality of terrestrial reference points AMER (hereinafter referred to as landmarks) as well as items of information relating to the graphical representations of the terrestrial reference points AMER. By way of example, the terrestrial reference points may be a runway, a navigation light, a Precision Approach Path Indicator, etc. The image capture device CAM comprises at least one camera onboard the vehicle and possessing a sensor of electromagnetic radiation, the wavelengths of which belong to the spectrum of visible and/or infrared light. According to an embodiment, the image capture device CAM comprises at least one video camera from among the following: a visible-light camera; a near-infrared camera, a short-wavelength infrared camera, a medium-wavelength infrared camera, and a long-wavelength infrared camera. The image capture device CAM is configured to capture a plurality of images for a plurality of measurement times.

The computer vision sensor VISION takes as input: the images captured by the image capture device CAM; and the navigation data OUT_LOC_VIS from the navigation module LOC_VISION, particularly the position of the vehicle. The sensor VISION is, according to an embodiment, configured to: detect the terrestrial reference points AMER in the captured images; and to determine the observed relative positions of the detected terrestrial reference points AMER with respect to the vehicle based on said captured images. The sensor VISION is moreover configured, according to an embodiment, to determine estimated relative positions of the detected terrestrial reference points AMER with respect to the vehicle based on a position of the vehicle determined by the navigation module LOC_VISION and on the known positions of the terrestrial reference points AMER. According to an embodiment, the data OUT_VIS provided by the sensor VISION comprise, for a plurality of measurement times, differences ax, ay between the observed and estimated relative positions of the terrestrial reference points AMER with respect to the vehicle. Typically, the relative position (observed or estimated) of a landmark with respect to the vehicle is defined by two angles-a lateral angle and a vertical angle-characterizing the line of sight of the landmark with respect to the longitudinal axis of the vehicle.

According to an embodiment, to detect a terrestrial reference point in an image, the sensor VISION is configured to select in this image a region of interest (i.e. in a portion of this image) and detect the terrestrial reference point in this region of interest. In particular, the coordinates of the region of interest are determined based on: the known position of the terrestrial reference point; the position of the vehicle determined by the navigation module LOC_VISION; and on an item of information provided by the navigation module LOC_VISION relating to the radius of protection of the determined position of the vehicle (i.e. the probability that the position error is less than the radius of protection is greater than a defined value, particularly very close to 1). The fact of using a region of interest allows to restrict the image portion to detect a landmark and thus allows to reduce the hardware and software resources (e.g. processing time, memory etc.) needed for the detection of a landmark in captured images.

Of course, the set of sensors SYS may comprise one or more of each of the sensors IMU, GPS, BARO, VISION as described above.

As illustrated by FIG. 1, the navigation device APP comprises, according to an embodiment: a navigation module LOC_ GPS (the so-called first navigation module); a navigation module LOC_VISION (the so-called second navigation module); and a control module SWITCH. The navigation modules LOC_GPS and LOC_VISION respectively provide navigation data OUT_LOC_GPS (the so-called first navigation data) and navigation data OUT_LOC_VIS (the so-called second navigation data). It should be noted that the navigation data LOC_GPS and LOC_VISION produce navigation data OUT_LOC_GPS and OUT_LOC_VIS independently and, more specifically, simultaneously (i.e. in parallel.) According to an embodiment, the navigation data OUT_LOC_GPS and OUT_LOC_VIS respectively comprise, for a plurality of measurement times, a position Pos, a velocity Vel and a direction Cap of the vehicle and associated protection radii PL.

It should be noted that the parallel use of the two separate navigation modules LOC_GPS and LOC_VISION allows to improve the integrity of the navigation system SYS of the vehicle and thus the resilience of the system SYS as regards malfunctions of the sensors used for navigation.

The navigation module LOC_GPS determines the navigation data OUT_LOC_GPS based on the data from the inertial measurement unit IMU, the satellite positioning module GPS, and the altimeter BARO.

As illustrated by FIG. 1, according to an embodiment, the navigation module LOC_GPS comprises: an inertial system NAV_IMU_GPS; and a Kalman filter KAL_FLT_GPS. The inertial system NAV_IMU_GPS is configured to integrate over time the specific force Fs and angular velocity Ω data produced by the inertial measurement unit IMU and thus determine navigation data Pos, Vel, Cap of the vehicle. The Kalman filter KAL_FILT_GPS determines, based on data from the sensors GPS and BARO, the corrections δPos, δVel, δCap, δFs, and δΩ to be applied to the inertial system NAV_IMU_GPS. The navigation data OUT_LOC_GPS provided as output thus correspond, according to an embodiment, to the navigation data determined by the inertial system NAV_IMU_GPS corrected (i.e. recalibrated) based on the data from the Kalman filter KAL_FLT_GPS. In other words, the Kalman filter KAL_FLT_GPS allows to offset the inertial navigation drift (i.e. recalibrate) based on the data from the sensors GPS and BARO.

Note that, when the satellite positioning module GPS is not operational (e.g.

unavailable, faulty, malfunctioning, or unusable), the navigation module LOC_GPS continues to produce as output the navigation data OUT_LOC_GPS. However, in this case, the navigation module LOC_GPS cannot exploit the data from the satellite positioning module GPS to palliate the drift (i.e. recalibrate) of the inertial system NAV_IMU_GPS. The same applies when the altimeter BARO is unavailable.

The navigation module LOC_VISION determines the navigation data OUT_LOC_VIS based on the data from the inertial measurement unit IMU, the satellite positioning module GPS, the altimeter BARO and the sensor VISION.

As illustrated by FIG. 1, the navigation module LOC_VISION has, according to an embodiment, a similar architecture to the navigation module LOC_GPS. According to this embodiment, the navigation module LOC_VISION comprises: an inertial system NAV_IMU_VIS; and a Kalman filter KAL_FLT_VIS.

The navigation data OUT_LOC_GPS provided as output thus correspond, according to an embodiment, to the navigation data determined by the inertial system NAV_IMU_VIS to which are applied the corrections determined by the filter KAL_FILT_VIS based on the data from the sensors GPS, BARO and VISION. In other words, the Kalman filter KAL_FLT_GPS allows to palliate the inertial navigation drift (i.e. recalibrate) based on the data from the sensors GPS, BARO and VISION.

In the scope of the invention, other embodiments could also be envisioned in which one of the navigation modules LOC_GPS and LOC_VISION or both respectively use a Kalman filter (e.g. an extended Kalman filter) taking as input the data from all or part of the sensors of the set SENS and producing as output said navigation data.

It should be mentioned that the navigation module LOC_VISION exploits, to recalibrate the inertial system NAV_IMU_VIS, the data from the other sensors GPS, BARO, VISION when these data are available. According to an example, the sensor VISION can only be used by the navigation module LOC_VISION to recalibrate the inertial system NAV_IMU_VIS following the detection of a landmark. According to another example, the navigation module LOC_VISION does not exploit the data from the satellite positioning module GPS, when the module GPS is malfunctioning or unusable.

However, it is important to emphasize that the navigation data determined at a given time are a function of the navigation data determined at the preceding times.

Specifically, the inertial systems NAV_IMU_GPS and NAV_IMU_VIS integrate over time the specific force Fs and angular velocity Ω data produced by the inertial measurement unit IMU to determine navigation data OUT_LOC_GPS and OUT_LOC_VIS. Also, small errors of measurement of the specific force Fs and of the angular velocity 22 are integrated over time by the inertial systems and thus lead to velocity and position errors that increase over time (i.e. inertial navigation drift).

Consequently, the fact of using, at a given time, a sensor to recalibrate an inertial system allows to improve the accuracy of the navigation data determined at the subsequent times.

Suppose for example that during a first period, the navigation module LOC_VISION uses the data of the module GPS to offset the drift of the inertial system NAV_IMU_VIS. Then, during a second later period, the satellite positioning module GPS is no longer available. During the second period, although the module GPS is no longer available, the navigation module LOC_VISION determines more accurate navigation data OUT_LOC_VIS than a navigation module that never exploits the data of a module GPS. This is because the navigation module LOC_VISION benefits during the second period from the recalibration of the inertial system during the first period.

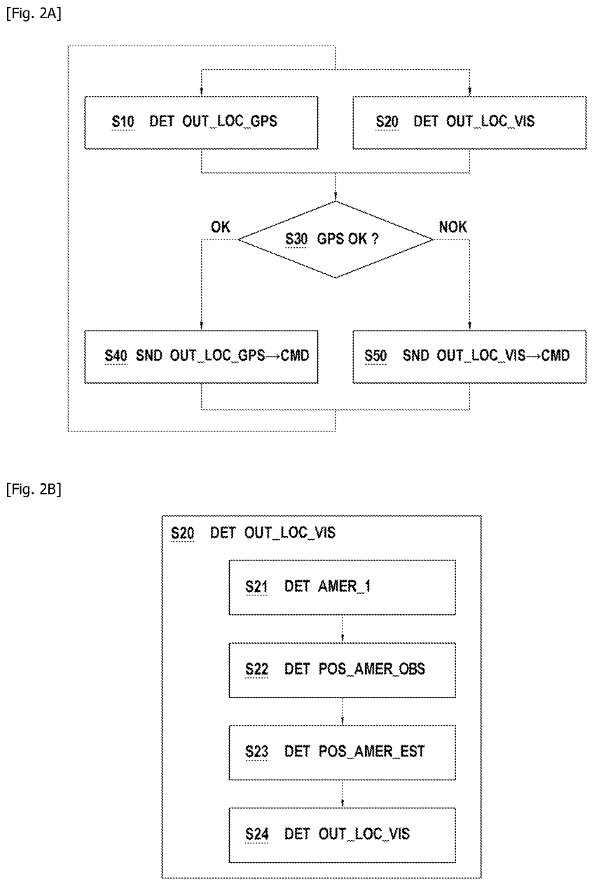

The control module SWITCH receives the navigation data OUT_LOC_GPS and OUT_LOC_VIS respectively produced by the navigation modules LOC_GPS and LOC_VISION and provides to the guiding module CMD the navigation data IN_NAV_CMD. According to an embodiment, the control module SWITCH provides the guiding module CMD with either the navigation data OUT_LOC_GPS, or the navigation data OUT_LOC_VIS. In particular, the control module SWITCH is configured to select the navigation data to be provided as a function of the availability (i.e. operational or non-operational) of the satellite positioning module GPS, this embodiment being detailed hereinafter with reference to FIGS. 2A and 2B.

FIGS. 2A and 2B show, schematically and in the form of a flow chart, steps of a navigation method according to an embodiment of the invention.

As illustrated by FIGS. 2A and 2B, and according to an embodiment of the invention, the proposed navigation method comprises at least one of the following steps S10 to S50 implemented by the navigation system SYS for which provision is made. According to a particular embodiment, the steps S10 to S50 are implemented in a chronological order as described hereinafter.

During the step S10, the navigation module LOC_GPS determines navigation data OUT_LOC_GPS of the vehicle based on the data from the inertial measurement unit IMU, the satellite positioning module GPS, and the altimeter BARO.

During the step S20, the navigation module LOC_VISION determines navigation data OUT_LOC_VISION of the vehicle based on data from the inertial measurement unit IMU, the satellite positioning module GPS, the altimeter BARO, and the computer vision sensor VISION. According to an embodiment, the step S20 comprises sub-steps S21 to S24 detailed below with reference to FIG. 2B.

The steps S10 and S20 can be performed simultaneously, one in front of the other or conversely. According to a particular embodiment, the steps S10 and S20 are performed in parallel.

As mentioned previously, if one of the sensors GPS, BARO, or VISION is not operational (e.g. unavailable, faulty, malfunctioning, or unusable), the navigation modules LOC_GPS and LOC_VISION continue to produce as output the navigation data OUT_LOC_GPS and OUT_LOC_VIS. However, in this case, the navigation modules LOC_GPS and LOC_VISION cannot exploit the data from the non-operational sensor to offset the drift of (i.e. recalibrate) the inertial systems NAV_IMU_GPS and NAV_IMU_VIS.

In particular, the navigation modules LOC_GPS and LOC_VISION use the data OUT_GPS from the satellite positioning module GPS (only) when the latter is operational. Correspondingly, the navigation modules LOC_GPS and LOC_VISION do not use the data OUT_GPS from the satellite positioning module GPS when the latter is not operational.

During the step S30, the control module SWITCH determines whether or not the satellite positioning module GPS is operational (i.e. available and usable). By way of illustration, the satellite positioning module GPS may not be operational (i.e. malfunctioning, faulty) because of a malfunction of one of the satellites of the constellation GPS, or a malfunction of the onboard GPS module itself. During the step S30, the control module SWITCH implements, according to an embodiment, a step of detection of faults (i.e. of malfunction) of the satellite positioning module GPS to determine whether or not the satellite positioning module GPS is operational.

During the step S40, if, and only if, it has been determined in the step S30 that the satellite positioning module GPS is operational, the control module SWITCH provides the navigation data OUT_LOC_GPS to the guiding module CMD of the vehicle.

During the step S50, if it has been determined in the step S30 that the satellite positioning module GPS is not operational (the module GPS being unavailable, malfunctioning, faulty or unusable), the control module SWITCH provides the navigation data OUT_LOC_VIS to the guiding module CMD of the vehicle.

Following the step S50, the navigation system implements, according to an embodiment, the steps S10 and S20 detailed previously. Thus, the proposed navigation method comprises, according to this embodiment, several iterations of the steps S10 to S50 described above.

As illustrated by FIG. 2B, the step S20 comprises, according to an embodiment, at least one of the steps S21 to S24 detailed hereinafter with reference to FIG. 2B and implemented by the navigation system SYS for which provision is made.

During the step S21, the sensor VISION detects at least one terrestrial reference point AMER in images captured by the image capture device CAM.

According to a particular embodiment, to detect a terrestrial reference point AMER in an image, the sensor VISION implements the following steps. The sensor VISION selects a portion of this image (i.e. a region of interest), the coordinates of the image portion being determined based on: the known position (e.g. geographical coordinates) of the terrestrial reference point AMER; on the position of the vehicle determined by the navigation module LOC_VISION; and on an item of information relating to the accuracy of the position of the vehicle provided by the of navigation module LOC_VISION (i.e. the radius of protection). Following the selection of the image portion, the sensor VISION detects the terrestrial reference point AMER in the image portion.

During the step S22, the sensor VISION determines an observed relative position POS_AMER_OBS of the detected terrestrial reference point AMER with respect to the vehicle based on the captured images.

During the step S23, the sensor VISION determines an estimated relative position POS_AMER_EST of the detected terrestrial reference point AMER with respect to the vehicle based on a position of the vehicle provided by the navigation module LOC_VISION and on a known position of the terrestrial reference point AMER.

During the step S24, the sensor VISION provides to the navigation module LOC_VISION the difference ax, ay between the observed relative position POS_AMER_OBS and the estimated relative position POS_AMER_EST of the terrestrial reference point AMER with respect to the vehicle; and the navigation module LOV_VISION determines navigation data OUT_LOC_VIS particularly based on this difference αx, αy.

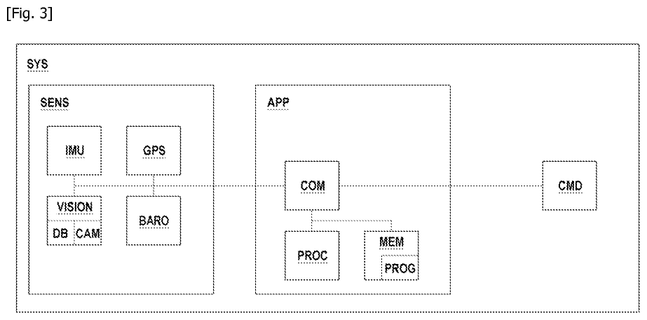

FIG. 3 schematically represents an example of a software and hardware architecture of a navigation system according to an embodiment of the invention.

As illustrated by FIG. 3, according to an embodiment, the navigation device APP comprises: at least one processing unit or processor PROC; and at least one memory MEM.

The device APP has, according to an embodiment, the hardware architecture of a computer and includes, in this regard, a processor PROC, a random-access memory, a read-only memory MEM, and a non-volatile memory. The memory MEM associated with the device APP constitutes an information or recording medium in accordance with the invention, readable by a computer and by the processor PROC, on which is recorded a computer program PROG in accordance with the invention.

The computer program PROG includes instructions for performing the steps of a method in accordance with the invention and implemented by the device APP, when the computer program PROG is executed by the processor PROC.

As illustrated by FIG. 3, according to an embodiment, the device APP has a communication module COM configured to communicate with at least one of the following elements: one or more sensors of the set of sensors SENS; and the guiding module CMD. Of course, no limitation is attached to the nature of the communication interfaces between the device APP and respectively: the sensors of the set SENS; and the guiding module CMD, which can be wired or wireless, and can implement any protocol known to those skilled in the art (Ethernet, Wi-Fi, Bluetooth, 3G, 4G, 5G, 6G, etc.).

According to an embodiment (not shown), the sensor VISION (also known as the computer vision device) has the hardware architecture of a computer and in this regard includes a processor PROC, a random-access memory, a read-only memory, and a non-volatile memory. In the embodiment described here, the memory associated with the sensor VISION constitutes an information medium, readable by a computer and on which is recorded a computer program. This computer program PROG includes instructions for performing the steps of a method in accordance with the invention and implemented by the sensor VISION, when this computer program is executed by a processor.

The navigation system SYS allows to accurately determine the navigation data of a vehicle while guaranteeing a high level of integrity, allowing the navigation system SYS to be integrated into a critical system, such as an aircraft.

In particular, the navigation system SYS allows to ensure a high level of integrity, while significantly relaxing the restrictions of integrity risk per hour on the computer vision sensor VISION. In other words, the navigation system SYS allows to ensure a high level of integrity, even with a computer vision sensor VISION of low maturity.

Take for example a reference navigation system comprising a single navigation module exploiting data from an inertial measurement unit, a satellite positioning module and a computer vision sensor. Such a navigation system does not allow to ensure a high level of integrity and could not be integrated into a critical system.

Specifically, the conditions of integrity risk per hour to be met for the computer vision sensor are not achievable with this reference system, due to the lack of maturity of the computer vision sensor and computer vision techniques.

By comparison with the aforementioned reference system, the navigation system SYS has two navigation modules LOC_GPS and LOC_VISION and makes the use of the computer vision sensor VISION conditional on situations for which the satellite positioning module GPS is not available. Thus, the navigation system SYS and, more specifically, the architecture of the navigation device APP allow to significantly relax the restrictions on the integrity risk per hour to be met for the computer vision sensor VISION.

The term module may correspond just as well to a software component as to a hardware component or to a set of hardware and software components, a software component itself corresponding to one or more computer programs or sub-programs or more generally to any element of a program able to implement a function or a set of functions as described for the modules in question. Similarly, a hardware component corresponds to any element of a set of hardware able to implement a function or a set of functions for the module in question (integrated circuit, chip card, memory card, etc.).

Note that the order in which the steps of a method in accordance with the invention, particularly with reference to the attached drawings, constitutes only an exemplary embodiment devoid of any limitation, variants being possible.

Those skilled in the art will understand that the embodiments and variants described above constitute only non-limiting exemplary implementations of the invention. In particular, those skilled in the art may envision any adaptation or combination of the embodiments and variants described above in order to meet a particular requirement.

1. A navigation method for a vehicle, said method comprising steps of:
determining, by a first navigation module, first navigation data of said vehicle based on data from an inertial measurement unit and from a satellite positioning module; and
determining, by a second navigation module, second navigation data of said vehicle, based on: data from the inertial measurement unit, and from images captured by said vehicle; and moreover based on data from said satellite positioning module and/or from an altimeter.

2. The method as claimed in claim 1, wherein:
the first navigation module and the second navigation module use the data from the satellite positioning module-when the satellite positioning module is operational;
said method comprises steps of:
if said satellite positioning module is operational providing said first navigation data to a guiding module of said vehicle; and
otherwise, providing said second navigation data to said guiding module of said vehicle; and
said method comprises several iterations of said determining and providing steps.

3. The method as claimed in claim 1, wherein the first and second navigation modules respectively comprise an inertial system and a Kalman filter to determine said first and second navigation data.

4. The method as claimed in claim 1, comprising steps of:
detecting at least one terrestrial reference point in said captured images;
determining an observed relative position of said at least one detected terrestrial reference point with respect to said vehicle based on said captured images;
determining an estimated relative position of said at least one detected terrestrial reference point with respect to said vehicle based on a position of said vehicle determined by the second navigation module and on a known position of said at least one terrestrial reference point; and
determining said second navigation data based on the difference between the observed and estimated relative positions of said at least one terrestrial reference point with respect to said vehicle.

5. The method as claimed in claim 4, wherein said step of detecting at least one terrestrial reference point in the captured images comprises steps of:
selecting a portion of at least one captured image, the coordinates of said portion being determined based on a known position of said at least one terrestrial reference point, on a position of said vehicle determined by the second navigation module and on an item of information relating to the accuracy of said determined position of said vehicle provided by the second navigation module; and
detecting said at least one terrestrial reference point in said portion of said at least one captured image.

6. A navigation device for a vehicle, said device comprising:
a first navigation module configured to determine first navigation data of said vehicle based on data from an inertial measurement unit and from a satellite positioning module; and
a second navigation module configured to determine second navigation data of said vehicle based on: data from the inertial measurement unit and from images captured by said vehicle; and moreover based on data from said satellite positioning module and/or from an altimeter

7. A navigation system for a vehicle, said system comprising:
a navigation device as claimed in claim 6;
an inertial measurement unit;
a satellite positioning module; and
an image capture device

8. The navigation system as claimed in claim 7, comprising a computer vision device configured to determine at least one position of the vehicle based on the images captured by said image capture device-.

9. The navigation system as claimed in claim 7, comprising a guiding module configured to guide said vehicle based on navigation data determined by said navigation device

10. A vehicle comprising a navigation system as claimed in claim 7.

11. A computer program comprising instructions for implementing the steps of a method as claimed in claim 1, when said computer program is executed by at least one processor.

12. An information medium readable by a computer comprising a computer program as claimed in claim 11.
